(19) United States
(12) Patent Application Publication
(10) Pub. No.: US 2005/0160287 A1
(43) Pub. Date: Jul. 21, 2005

(54) Method to deploy wireless network security with a wireless router

(75) Inventors: Pratik M. Mehta, Austin, TX (US); Balaji Mittapalli, Austin, TX (US)

Correspondence Address: BAKER BOTTS, LLP, 910 LOUISIANA, HOUSTON, TX, 77002-4995, US

(73) Assignee: Dell Products L.P., Round Rock, TX (US)

(21) Appl. No.: 10/758,889

(22) Filed: Jan. 16, 2004

(51) Int. Cl. H04L 9/00

(52) U.S. Cl. 713/200

(57) ABSTRACT

A method to deploy wireless network security with a wireless router is disclosed. In one aspect, the present disclosure teaches a method for activating a wireless network security with a wireless host including establishing a communication connection with a client. The method further includes, in response to the communication connection, automatically requesting from the client a determination of whether to activate the wireless network security. The method further includes, upon receipt of the determination to activate the wireless security network, automatically requesting an identifier code from the client. The method further includes activating the wireless security network to secure the wireless host if the identifier code matches a unique key-code that is physically located on the wireless host.

### TECHNICAL FIELD

The present disclosure relates generally to wireless networking systems and, more particularly, to a method to deploy wireless network security with a wireless router.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A typical networking system allows the computers and other devices, such as computer peripherals, in the network to share resources between each other. Generally, the networking system utilizes a host, such as a router, to provide access and communications between the various components. For example, the router may handle several packets of information for multiple computers connected on the network by matching packet addresses.

In addition to routing information between the components, the router also functions to prevent unauthorized users from accessing the networking system. Typically, the security features for both wireless and wired applications include a password or some combination of passwords. The password allows the host to recognize the computer (or user) such that access to the networking system is granted.

Generally, a greater security concern arises when operating in a wireless environment, because in a wired environment the potential for unauthorized access by a physical connection (i.e., a wire connecting directly to a router), although possible, is limited. In a wireless environment, access to the network is possible depending on the distance from the router. Thus, access to the networking system may be gained despite the presence of a wall when operating in a wireless environment.

Given the difficulty experienced by many computer users in establishing a wireless networking system, manufacturers who include security features in their wireless routers typically ship these devices with the security features turned off. Although disabling the security feature helps ease installation of the various computer components in the network, many users do not enable the security feature once the system is configured. Other users simply find it difficult to correctly configure the security feature, which can result in costly support calls to the manufacturer and less satisfactory user experience.

### SUMMARY

Thus, a need has arisen for a method to deploy a wireless network security with a wireless router.

Further, a need has arisen for a method to deploy a wireless network security that preserves a positive user experience.

In accordance with teachings of the present disclosure, in some embodiments, a method for activating a wireless network security with a wireless host including establishing a communication connection with a client. The method further includes, in response to the communication connection, automatically requesting from the client a determination of whether to activate the wireless network security. The method further includes, upon receipt of the determination to activate the wireless security network, automatically requesting an identifier code from the client. The method further includes activating the wireless security network to secure the wireless host if the identifier code matches a unique key-code that is physically located on the wireless host.

In other embodiments, a method of accessing a secured wireless network deployed from a wireless router using a client includes establishing a communication connection with a client. The method further includes, in response to the communication connection, automatically requesting from the client an identifier code to access the secured wireless network. The method further includes allowing access to the secured wireless network on the wireless router if the identifier code matches a unique key-code that is physically located on the wireless router.

In further embodiments, a system for deploying a wireless network security with a wireless router includes a wireless router having a unique key-code physically located on the router and a client. The client operably maintains a communication connection with the router. The client activates a wireless security network to secure the router if the client transmits an identifier code to the router wherein the identifier code matches a unique key-code that is physically located on the router.

All, some, or none of these technical advantages may be present in various embodiments of the present invention. Other technical advantages will be apparent to one skilled in the art from the following figures, descriptions, and claims.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 depicts a network system connected to the Internet using a wireless router, according to teachings of the present disclosure; and

FIG. 2 is a flowchart for an example embodiment of a method to deploy a wireless network security using a router, according to the present disclosure.

### DETAILED DESCRIPTION

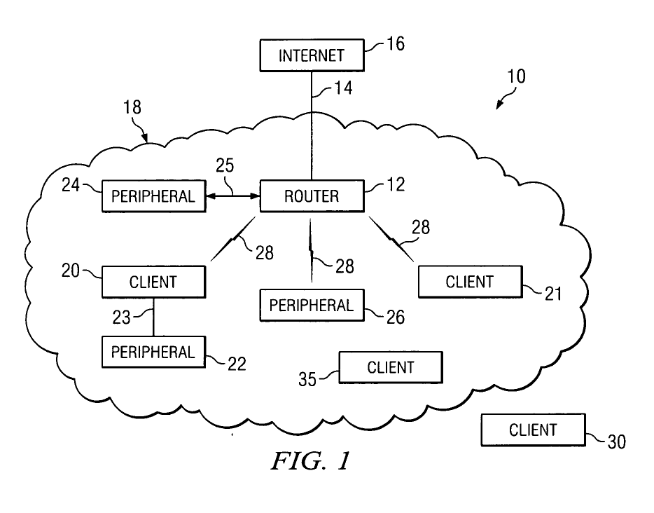

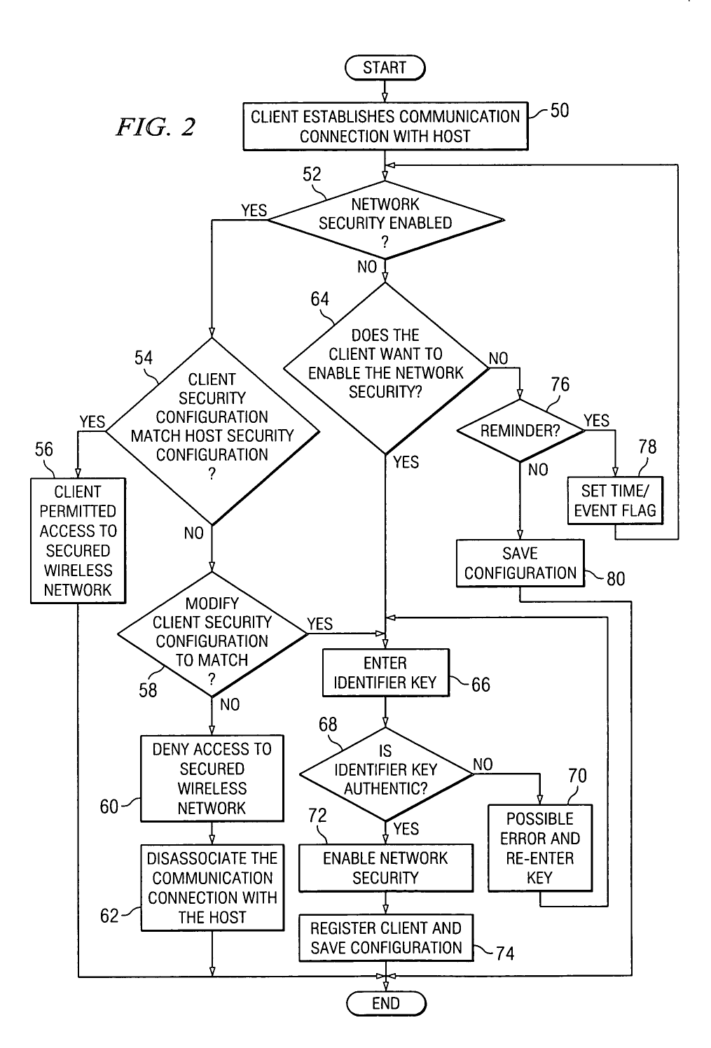

Preferred embodiments and their advantages are best understood by reference to FIGS. 1 and 2, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

FIG. 1 depicts network system 10 connected to Internet 14 using wireless host 12. Although network system 10 is shown connected to Internet 14, in other embodiments, network system 10 may connect other information handling systems, other network systems (not shown) or merely be a stand-alone network system.

Network systems 10 typically use a host, router or access point to interconnect the various components using networking system 10. Hosts, routers or access points can be computer hardware or software that acts as a communication hub for users of a wireless device to connect to a wired local area network. An example of a host includes a router, an access point, a gateway, a broadband router/gateway or some combination thereof. These hosts may be wired, wireless or some combination thereof. Hosts are important for providing heightened wireless security and for extending the physical range of service a wireless user has access to via access points. One example of a host is wireless host 12.

Generally, wireless host 12 such as a router includes a wired connection for access to Internet 16 via Internet connection 14. In some instances, wireless host 12 may also include wired connections to allow access to network system 10 such as a local area network or LAN. For example, one or more peripheral computer component 24 may be directly connected to wireless host 12 via peripheral wired connection 25. Examples of computer peripherals include printers, scanners, facsimiles, digital cameras, computer modems, computers, joysticks, web-cameras, personal digital assistants (PDAs), mice, and keyboards.

Wireless host 12 transmits and receives wireless signals that allow computer components to communicate on wireless network 10, which is generally a wireless network. Wireless signals provide wireless connection 28 that stands in place of a physical connection, such as a cable. This virtual connection allows information handing systems including computer systems (e.g., clients 20, 21 and 35) to communicate to devices on network 10 such as computers and peripherals including stand-alone peripheral 26 using a virtual cable. Although a particular embodiment of wireless network system 10 is depicted with wireless connection 28 replacing a physical connection between the computers and stand-alone peripheral 26, the techniques of various embodiments of the present invention are adaptable to a wide variety of virtual connections in place of physical connections.

Depending on the type of wireless system, the boundaries of communication of wireless host 12 are limited to signal range 18 such that communications, and possibly access to the network, can be established within signal range 18. For example, communication with clients 20, 21 and 35 can be established since all are within signal range 18 of wireless host 12. However, client 30, another example of an information handling system, lies outside of signal range 18 and, as such, is unable to establish communication with wireless host 12.

Generally, being within signal range 18 does not automatically determine that a device is connected or will connect to network system 10. For example, client 35, despite being within signal range 18, may or may no not access or connect with network system 10. Generally, when an information handling system such as client 35 enters within signal range 18, client 35 will attempt to connect with network system 10. However, if client 35 does not have access to network system 10 (e.g., user does not know the access code), client 35 may choose to remain within signal range 18 but not connect to network system 10 or to connect at some later time. Even if client 35 has access privileges to connect with network system 10, client 35 may elect to stay within signal range 18 but remain a separate device not connected to network system 10.

In some embodiments, any device on network system 10 may access another device that is connected to computer on network 10. For example, client 21 may access computer-connected peripheral 22 that connected to client 20 via cable 23. In such an arrangement, access to computer-connected peripheral 22 is usually provided though client 20 such that client 20 is configured to allow access to computer-connected peripheral 22.

The respective physical connections between client 20 and computer-connected peripheral 22 can include any suitable form of communication, including Internet protocol (IP), Ethernet, asynchronous transfer mode (ATM), and synchronous optical network (SONET), and/or serial protocols, such as RS232, IEEE 1394, or Universal Serial Bus (USB) 1.1 or 2.0. Client 21 and computer-connected peripheral 22 may use different communication protocols, so that wireless connection 28 replaces both the physical connection and any intervening protocol converters.

Wireless connection 28 itself may include any number and type of intervening protocols, whether wired or wireless, examples of which include IP, ATM, SONET, serial protocols, Ethernet, radio frequency coaxial cable, RS 232, Firewire, General Packet Radio Service (GPRS), 802.11 WiFi, satellite links, or any other communication protocol in any suitable medium. In general, wireless connection 28 may include any number or combination of wireless and/or wired segments.

Clients 20, 21, 30 and 35 represents any collection of hardware or software components for processing and exchanging information, running applications, generating output, performing calculations, or any other suitable computing task. Generally, clients 20, 21, 30 and 35 include an information handling system but other examples include personal computers (PCs), laptops, and servers. As such, client 20, 21, 30 and 35 include any necessary or suitable microprocessing components, such as microprocessors, micro-controllers, or digital signal processors (DSPs), and memory components, such as optical storage, magnetic storage, or removable media, whether volatile or non-volatile. Clients 20, 21, 30 and 35 may also include inputs and outputs allowing clients 20, 21, 30 and 35 to exchange information with users.

In order to communicate with computer-connected peripheral 22, client 20 exchanges information according to a communications protocol using a physical connection such as cable 23. Cable 23 represents any suitable physical medium for communicating information including insulated wires, shielded twisted pairs, coaxial cable, optical fiber, or any other physical connection for propagating signals. The communication protocol used to communicate the information may be any suitable protocol for the medium, examples of which include Internet protocol (IP), Ethernet asynchronous transfer mode (ATM), and synchronous optical network (SONET), and/or serial protocols, such as RS232, IEEE 1394, or Universal Serial Bus (USB) 1.1 or 2.0.

Wireless host 12 may also include one or more security features to prevent unauthorized access to wireless network 10. In operation, the security features prevent unauthorized users from accessing wireless network 10. Unauthorized users may include any user or client that has not previously connected or registered with wireless host 12 or network 10. For example, client 35 may be an unauthorized user such that client 35 may move within signal range 18 but remain excluded from accessing network 10. As such, wireless host 12 may be programmed with a unique key-code, and establish connections only with devices that indicate possession of the unique key-code during an authentication process.

Generally, the security features of wireless host 12 are at a default factory value of being disabled or deactivated. To facilitate user activation of the security features, wireless host 12 is programmed with a method to deploy a wireless network security in accordance with the present disclosure.

FIG. 2 is a flowchart for an example embodiment of a method to deploy a wireless network security using a router. At block 50, a client such as a computer moves within signal range 18 of a host such as wireless host 12 and establishes communication connection with a host. Upon establishing the connection, the method of deploying the wireless security network automatically determines if the network security is enabled such that network 10 is secured, at block 52.

If network 10 is secured, wireless host 12 performs a check of the client security configuration. In some example embodiments, wireless host 12 uses a profile or a service set identifier (SSID) to recognize the configuration of the client. Typically, the profile or SSID is stored in memory on the client such that wireless host 12, while establishing communications with the client, can recognize the SSID. The check determines if the client security configuration matches the host security configuration as shown in block 54. Typically, the host security configuration is a unique key-code physically located on wireless host 12. For example, a label including a local area network (LAN) media access control (MAC) address that is supplied with wireless host 12. In some instances, the unique key-code is supplied on a service tag that is supplied with wireless host 12. Generally, this unique key-code is the default setting from the factory, which can be reset by a user.

At block 56, the client is granted access to the secured wireless network, if the client security configuration is determined to match host security configuration. In some embodiments, information regarding the client is already saved in the configuration of wireless host 12 such that wireless host 12 recognizes the client.

If the client security configuration does not match, the client is provided an opportunity to modify the security configuration at block 58. Selecting to modify the security configurations requests the client enter the unique key-code or identifier key at block 66. However, a client who selects not to modify the security configuration is denied access to the secured wireless network at block 60. In some embodiments, wireless host 12 disassociates communications with the client as shown in block 62. Typically, the disassociation permits the client to resume normal functions as a stand-alone computer that is not connected to network 10.

Returning to block 52, if the network security was not enabled, the method request from the client a determination to activate the wireless security network at block 64. Typically, wireless host 12 transmits a message to the client requesting that the client determine if security is to be enabled or activated.

If the client does not wish to activate the network security, wireless host 12 automatically requests if the client would like to be reminded at some future time to activate the network security, at block 76. Generally, selecting to be reminded, wireless host 12 sets a reminder flag for that particular client at block 78. In one embodiment, a selection of a reminder flag affects any future communications with wireless host 12 by any client accessing the network.

Reminder flags are generally set based on the expiration of a time period such as a reminder time period. Alternatively, the reminder flag may include a reminder condition such that upon the occurrence of a condition the reminder flag is triggered. For example, a reminder condition may include a subsequent communication connection such as the next communication connection between a client and wireless host 12. In some embodiments, the client may elect to never be reminded, such as a never-remind response. Under these conditions, the client will not be prompted to enable the network security and must initiate communication with wireless host 12 to enable the security feature. In any event, once the reminder flag is set, wireless host 12 may save the configuration information by registering that particular client. For example, if client 20 sets a two week reminder flag, client 21 may be prompted for enabling the security features on the next communication with wireless host 12 since the reminder flag was set for client 20.

Selecting to activate or enable the network security, the client is requested to enter an identifier key at block 66. At block 68, the identifier key is authenticated against the unique key-code. An incorrect code causes wireless host 12 to request the client to re-enter the code again at block 70.

If the code is authentic, the identifier key matches the unique key-code such that the network security is enabled at block 72. Generally, after securing network 10, the client is registered with wireless host 12. In certain embodiments, the client saves the security configuration such that subsequent communication connections with wireless host 12 permits wireless host 12 to identify the client.

In some embodiments, once access is granted to the secured network, a user operating from a client that is permitted access to network 10 may be able to change the unique key-code to a personal code that is selected by the user.

With the network security enabled, any previously set reminder flags are removed. Because each subsequent communication with a client will be on secured wireless network 10, any client not matching the correct security configuration will be denied access to wireless network 10. For example, if client 20 had set a reminder flag for two weeks and client 21 activates the network security, client 20 will be prompted for the correct security configuration on the next attempt to access wireless network 10.

Although the disclosed embodiments have been described in detail, it should be understood that various changes, substitutions and alterations can be made to the embodiments without departing from their spirit and scope.

1. A method for activating a wireless network security with a wireless host, comprising:
establishing a communication connection with a client;
in response to the communication connection, automatically requesting from the client a determination of whether to activate the wireless network security;
upon receipt of the determination to activate the wireless security network, automatically requesting an identifier code from the client; and 52
activating the wireless security network to secure the wireless host if the identifier code matches a unique key-code that is physically located on the wireless host.

2. The method of claim 1, further comprising registering the client with the wireless host such that the wireless host is able to identify the client upon subsequent connections.

3. The method of claim 1, further comprising saving the configuration setting on the client as part of a profile or a service set identifier (SSID) such that access to the wireless host is maintained.

4. The method of claim 1, further comprising following the activation of the wireless security network, changing the unique key-code to a personal code selected by the client.

5. The method of claim 4, further comprising resetting the unique key-code to a factory default.

6. The method of claim 1, further comprising, in response to the determination of not to activate the wireless network security, setting a reminder flag.

7. The method of claim 6, wherein the remainder flag comprises a reminder time period such that a second request is made from the client for the determination to activate the wireless security network after the expiration of the reminder time period.

8. The method of claim 6, wherein the reminder flag comprises a reminder condition such that a second request is made from the client for the determination to activate the wireless security network upon a subsequent communication connection.

9. The method of claim 6, wherein the reminder flag comprises a never-reminder response.

10. The method of claim 6, further comprising registering the client to save configuration information on the client such that the wireless host recognizes the client on a subsequent communication connection.

11. A method of accessing a secured wireless network deployed from a wireless router using a client, comprising:
establishing a communication connection with a client;
in response to the communication connection, automatically requesting from the client an identifier code to access the secured wireless network; and
allowing access to the secured wireless network on the wireless router if the identifier code matches a unique key-code that is physically located on the wireless router.

12. The method of claim 11, further comprising denying access to the secured wireless network if the identifier code supplied by the client does not match the unique key-code.

13. The method of claim 12, further comprising, in response to denying access to the secured wireless network, disassociating the communication connection with the wireless router.

14. The method of claim 11, further comprising, in response to allowing access to the secured wireless network, changing the unique key-code that is physically located on the wireless router to a personal code supplied by the client.

15. The method of claim 10, further comprising registering the client with the wireless router such that the wireless router is able to identify the client upon subsequent connections.

16. The method of claim 10, further comprising saving the configuration setting on the client as part of a profile or a service set identifier (SSID) such that access to the wireless host is maintained.

17. A system for deploying a wireless network security with a wireless router, comprising:
a wireless router having a unique key-code physically located on the router;
a client operably maintains a communication connection with the router, the client operable to activate a wireless security network to secure the router if the client transmits an identifier code to the router wherein the identifier code matches a unique key-code that is physically located on the router.

18. The system of claim 17, wherein the unique key code is a service tag supplied with the router.

19. The system of claim 17, wherein the unique key code is a local area network (LAN) media access control (MAC) address supplied with the router.

20. The system of claim 17, wherein the client is an information handling system.
